(19) United States
(12) Patent Application Publication
(10) Pub. No.: US 2011/0314011 A1
(43) Pub. Date: Dec. 22, 2011

(54) AUTOMATICALLY GENERATING TRAINING DATA

(75) Inventors: Greg Buehrer, Issaquah, WA (US); Paul Viola, Seattle, WA (US); Andrew McGovern, Seattle, WA (US); Sanaz Ahari, Bellevue, WA (US); Mukund Narasimhan, Bellevue, WA (US)

(73) Assignee: MICROSOFT CORPORATION, REDMOND, WA (US)

(21) Appl. No.: 12/818,377

(22) Filed: Jun. 18, 2010

(51) Int. Cl. G06F 17/30

(52) U.S. Cl. 707/728; 707/769; 707/E17.014

(57) ABSTRACT

Computer-readable media, computer systems, and computing devices facilitate generating binary classifier and entity extractor training data. Seed URLs are selected and URL patterns within the seed URLs are identified. Matching URLs in a data structure are identified and corresponding queries and their associated weights are added to a potential training data set from which training data is selected.

### BACKGROUND

Web searching has become a common technique for finding information. Popular search engines allow users to perform broad based web searches according to search terms entered by the users in user interfaces provided by the search engines (e.g. search engine web pages displayed at client devices). A broad based search can return results that may include information from a wide variety of domains (where a domain refers to a particular category of information).

In some cases, users may wish to search for information that is specific to a particular domain. For example, a user may seek to perform a music search or to perform a product search. Such searches (referred to as “domain-specific searches”) are examples of searches where a user has a specific query intent for information from a specific domain in mind when performing the search (e.g. search for a particular song or recording artist, search for a particular product, and so forth). Domain-specific searching can be provided by a vertical search service, which can be a service offered by a general-purpose search engine, or alternatively, by a vertical search engine. A vertical search service provides search results from a particular domain, and typically does not return search results from domains un-related to the particular domain. One example of a specialized type of vertical-search service is referred to herein as an instant-answer service.

An instant answer refers to a search result that is an answer or response to a search query that is provided to a user on the main search results page. That is, a user is presented with domain-specific content on the search results page in response to a query, whereas the user might otherwise be required to select a link within the search results page to navigate to another webpage and, thereafter, search further for the desired information. For example, assume a user search query is “weather in Seattle.” An algorithm result within a search results page might include a URL to weather.com. In such a case, the user can select the URL, transfer to that webpage, and, thereafter, input Seattle to obtain the weather in Seattle. By comparison, an instant answer presented on the search results page contains the weather for Seattle such that a user is not required to navigate to another webpage to find the weather. As can be appreciated, an instant answer might pertain to any subject matter including, for example, weather, news, area codes, conversions, dictionary terms, encyclopedia entries, finance, flights, health, holidays, dates, hotels, local listings, math, movies, music, shopping, sports, package tracking, and the like. An instant answer can be in the form of an icon, a button, a link, text, a video, an image, a photograph, an audio, a combination thereof, or the like.

A query-intent classifier can be used to determine whether or not a query received by a search engine should trigger a vertical search service such as, for example, an instant answer service. For example, a dictionary-definition intent classifier can determine whether or not a received query likely is related to a dictionary-definition search. If the received query is classified as relating to a dictionary-definition search, then the corresponding vertical search service can be invoked to identify search results in the dictionary-definition search domain (which can include websites relating to dictionary-definition searching, for example). In one specific example, a dictionary-definition intent classifier may classify a query containing the search phase “define fidelity” as being positive as a dictionary-definition intent search, which would therefore trigger a vertical search for dictionary definitions of words and phrases including “fidelity.” On the other hand, the dictionary-definition intent classifier might classify a query containing the search phrase “Fidelity” (which is a name of a well-known financial organization) as being negative for (or as not being positive for) a dictionary-definition intent search, and therefore, would not trigger a vertical search service. Because “Fidelity” is the name of a well-known company, the presence of “fidelity” in the search phrase, taken alone, should not necessarily trigger a dictionary-definition-related domain-specific search or instant answer.

A challenge faced by developers of query-intent classifiers is that typical training techniques (for training the query-intent classifiers) have to be provided with an adequate amount of training data. In some cases, query-intent classifiers are trained using training data that has been labeled as either positive or negative for a query intent, while in other cases, query-intent classifiers are trained using only training data that is identified as positive training data. Building a classifier with insufficient training data can lead to an inaccurate classifier.

Traditionally, machine-learning binary query classifiers, which identify whether a given query is part of a particular domain such as, for example, music, movies, jobs, dictionary definitions, and the like, and entity extractors, which segment a query into a set of parts, have been expensive to build at a large scale because each requires tens of thousands of positive training-query samples. These samples have historically been labeled by human judges, who usually yield only several hundred samples per day and who result in a large amount of overhead expense.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the invention facilitate automatic generation of positive training data for classifiers and entity extractors. By implementing aspects of embodiments of the invention, a search service can generate positive in-domain training data at a large scale, allowing the creation of high-quality classifiers at a sufficiently high rate to keep up with search engines, for example, that are continuously expanding to build rich experiences across multiple domains. The methods described herein can be completely automated, thereby requiring no manual labeling (or labeling of any kind) of initial queries. Additionally, the algorithms described herein can be run efficiently on any number of servers, machines, or the like.

In some aspects of embodiments of the invention, a classifier is constructed by receiving a data structure that correlates queries to uniform resource locators (URLs) identified by queries. A set of seed (e.g., initial) URLs is selected and a domain, which includes one or more subdomains, is identified based on the URL. The data structure is then examined to identify each URL in the data structure that has a matching subdomain. All of the queries associated with each identified URL are added to a set of potential training data, from which queries meeting certain criteria are selected. The selected queries are then used as training data to train the classifier.

In some aspects of embodiments of the invention, an entity extractor is constructed by receiving a data structure that correlates queries to uniform resource locators (URLs) identified by queries. A set of seed (e.g., initial) URLs is selected and an entity pattern, which includes one or more entities (and can include an arrangement, orientation, and the like), is identified based on the URL. The data structure is then examined to identify each URL in the data structure that has a entity pattern. All of the queries associated with each identified URL are added to a set of potential training data, from which queries meeting certain criteria are selected. The selected queries are then used as training data to train the entity extractor.

For context, suppose a certain URL pattern (e.g. www.contoso.com/music/artist/) is identified as part of a specific domain (e.g. music), then, in some embodiments, an assumption might be made that most queries with clicks to URLs of that same pattern also have intent for the same domain (e.g. {coldplay albums} leads to clicks on www.contoso.com/music/artist/coldplay/albums.jhtml, so {coldplay albums} is likely music related). Furthermore, some such URLs are structured in such a way that relevant entity names can be extracted from the URLs themselves, which can facilitate labeling the same entity names as components of the query (in the same URL example above, the URL segment that follows “/artist/” is the actual artist name, “Coldplay”, which can then be used to label to the first term in the example query).

The techniques described herein provide for a scalable solution for generating large numbers of training queries from click data. For instance, large search engines can have click graph that contain, for example, every query issued by every user, and every user click on every URL, associated with each query, from, say, June 2009 to present. Once a few URL patterns have been identified, they can be automatically run against the click graph, with certain thresholds applied. The output of this process is a sufficiently large set of positive query samples for use in existing machine learning algorithms to create binary classifier and entity extractor classifier models. These models can be hosted at runtime and can be used to classify and segment user queries. Those queries that are deemed to have intent for a certain domain (e.g. music) are segmented into their component parts and fed into the domain's instant answer service, in order to retrieve in-domain content (e.g. top songs by an artist, including lyrics, a song play link, etc.).

Other or alternative features will become apparent from the following description, from the drawings, and from the claims.

### BRIEF DESCRIPTION OF THE DRAWINGS

Embodiments of the inventions are described in detail below with reference to the attached drawing figures, wherein:

FIG. 1 is a block diagram of an exemplary computing device suitable for implementing embodiments of the invention;

FIG. 2 is a block diagram of an exemplary network environment suitable for use in implementing embodiments of the invention;

FIG. 3 depicts an illustrative display of a click graph in accordance with embodiments of the invention;

FIG. 4 is a flow diagram illustrating an exemplary method of enhancing an instant-answer service in accordance with embodiments of the invention;

FIG. 5 is a flow diagram illustrating an exemplary method of utilizing a classifier and an entity extractor to trigger instant answer services in accordance with embodiments of the invention;

FIG. 6 is a flow diagram illustrating an exemplary method of identifying positive associations between queries and uniform resource locators (URLs) in click data with respect to a content domain in accordance with embodiments of the invention;

FIG. 7 is a flow diagram illustrating an exemplary method of generating positive classifier training data in accordance with embodiments of the invention; and

FIG. 8 is a flow diagram illustrating an exemplary method of generating entity-extractor training data from a data structure in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the invention described herein include computing devices and computer-program products (e.g., that include software) for facilitating automatic generation of training data for use in training query-intent classifiers and entity extractors. In a first illustrative embodiment, a set of computer-executable instructions provides an exemplary method of identifying positive associations between queries and uniform resource locators (URLs) in click data with respect to a content domain. In embodiments, aspects of the illustrative method include receiving a data structure correlating queries to URLs identified by the queries and identifying a first URL pattern associated with the content domain. In embodiments, aspects of the illustrative method further include determining that at least a portion of a first URL in the click graph matches the first URL pattern and identifying a first query correlated to the first URL. Various embodiments of the method include determining that the first query and the first URL have a positive association with respect to the content domain.

In a second illustrative embodiment, a set of computer-executable instructions provides an exemplary method of generating positive classifier training data. Embodiments of the method include, for example, receiving a data structure correlating queries to URLs identified by the queries. A URL pattern that includes a URL domain is identified and matching URLs and their corresponding queries in the data structure are also identified. Embodiments of the illustrative method further include adding each query connected with the matching URL to a set of potential training queries; and selecting a set of training queries from the set of potential training queries.

In a third illustrative embodiment, a set of computer-executable instructions provides an exemplary method for generating entity-extractor training data from a data structure storing click data, where the data structure includes associations between captured search queries and uniform resource locators (URLs) corresponding to query results that were selected. Embodiments of the illustrative method include selecting a seed URL and extracting a first entity pattern from the seed URL, the first entity pattern including a first entity. Matching URLs in the data structure are identified based on the extracted entity patterns. In embodiments, aspects of the illustrative method include adding each query connected with the matching URL to a set of potential training queries; and selecting a set of training queries from the set of potential training queries.

Various aspects of embodiments of the invention may be described in the general context of computer program products that include computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including dedicated servers, general-purpose computers, laptops, more specialty computing devices, and the like. The invention may also be practiced in distributed computing environments where tasks are performed by remote-processing devices that are linked through a communications network.

Computer-readable media include both volatile and nonvolatile media, removable and nonremovable media, and contemplate media readable by a database, a processor, and various other networked computing devices. By way of example, and not limitation, computer-readable media include media implemented in any method or technology for storing information. Examples of stored information include computer-executable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

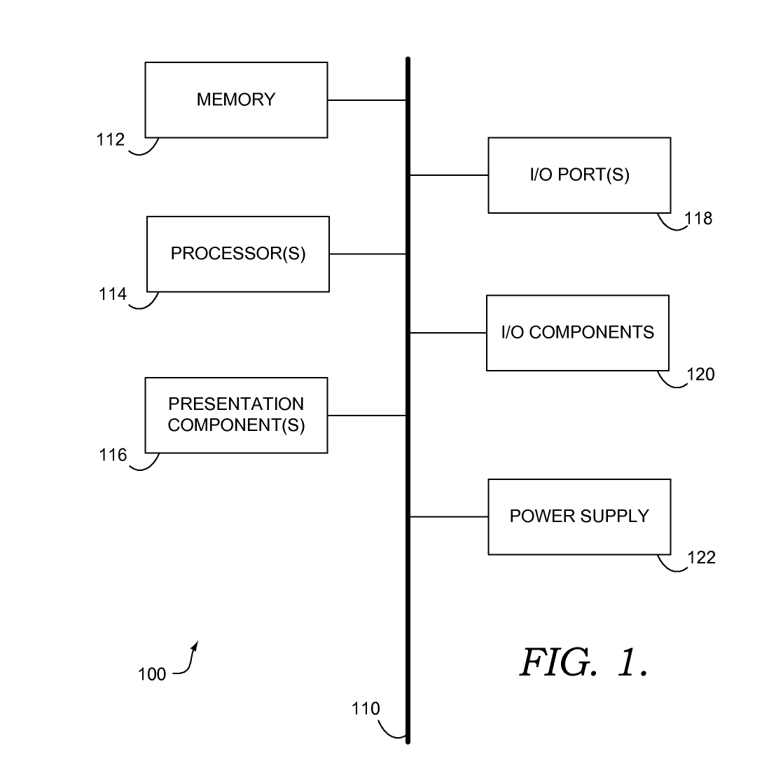

An exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Memory 112 includes computer-executable instructions 115 stored in volatile and/or nonvolatile memory. The memory may be removable, nonremovable, or a combination thereof. Exemplary hardware devices include solid-state memory, hard drives, optical-disc drives, etc. Computing device 100 includes one or more processors 114 coupled with system bus 110 that read data from various entities such as memory 112 or I/O components 120. In an embodiment, the one or more processors 114 execute the computer-executable instructions 115 to perform various tasks and methods defined by the computer-executable instructions 115. Presentation component(s) 116 are coupled to system bus 110 and present data indications to a user or other device. Exemplary presentation components 116 include a display device, speaker, printing component, etc.

I/O ports 118 allow computing device 100 to be logically coupled to other devices including I/O components 120, some of which may be built in. Illustrative components include a microphone, joystick, game pad, satellite dish, scanner, printer, wireless device, keyboard, pen, voice input device, touch input device, touch-screen device, interactive display device, or a mouse. I/O components 120 can also include communication connections 121 that can facilitate communicatively connecting the computing device 100 to remote devices such as, for example, other computing devices, servers, routers, and the like.

In accordance with some embodiments, a technique or mechanism of automatically generating training data for training a query-intent classifier includes receiving a data structure that correlates queries to URLs that are identified by the queries, and producing training data based on the data structure for training the query-intent classifier. A query-intent classifier is a classifier used to assign queries to classes that represent whether or not corresponding queries are associated with particular intents of users to search for information from particular domains (e.g., intent to perform a search for the definition of a word, intent to perform a search for a particular product, intent to search for music, intent to search for movies, etc.). Such classes are referred to as “query-intent classes.” A “domain” (or alternatively, a “query-intent domain”) refers to a particular category of information that a user wishes to perform search in.

In contrast, as used herein, “URL domain” and “URL subdomain” refer to an Internet domain and subdomain, respectively, which is generally defined by a portion of a URL. It should be understood that URL domains and URL subdomains may also be characterized, in some cases, as subdomains of a query-intent domain or even domains, if the query-intent is specific to a particular URL domain such as for example, a popular retail website domain.

The term “query” refers to any type of request containing one or more search terms that can be submitted to a search engine (or multiple search engines) for identifying search results based on the search term(s) contained in the query. The “items” that are identified by the queries in the data structure are representations of search results produced in response to the queries. For example, the items can be uniform resource locators (URLs) or other information that identify addresses or other identifiers of locations (e.g. websites) that contain the search results (e.g., web pages).

In one embodiment, the data structure that correlates queries to items identified by the queries can be a click graph that correlates queries to URLs based on click-through data. “Click-through data” (or more simply, “click data”) refers to data representing selections made by one or more users in search results identified by one or more queries. A click graph contains links (edges) from nodes representing queries to nodes representing URLs, where each link between a particular query and a particular URL represents at least one occurrence of a user making a selection (a click in a web browser, for example) to navigate to the particular URL from search results identified by the particular query. The click graph may also include some queries and URLs that are not linked, which means that no correlation between such queries and URLs has been identified.

In the ensuing discussion, reference is made to click graphs that contain representations of queries and URLs, with at least some of the queries and URLs correlated (connected by links). However, it is noted that the same or similar techniques can be applied with other types of data structures other than click graphs. In embodiments, the click graph correlating queries to URLs initially includes a large number of queries that have not been labeled (such as by one or more humans) with respect to query intent classes. In some embodiments, the click-graph includes some labeled queries.

Generally, the query intent classes can be binary classes that include a positive class and a negative class with respect to a particular query intent. A query labeled with a “positive class” indicates that the query is positive with respect to the particular query intent, whereas a query labeled with the “negative class” means that the query is negative with respect to the query intent. In addition to queries that are labeled with respect to query intent classes, the click graph initially can also contain a relatively large number of queries that are unlabeled with respect to query intent classes. The unlabeled queries are those queries that have not been assigned to any of the query intent classes.

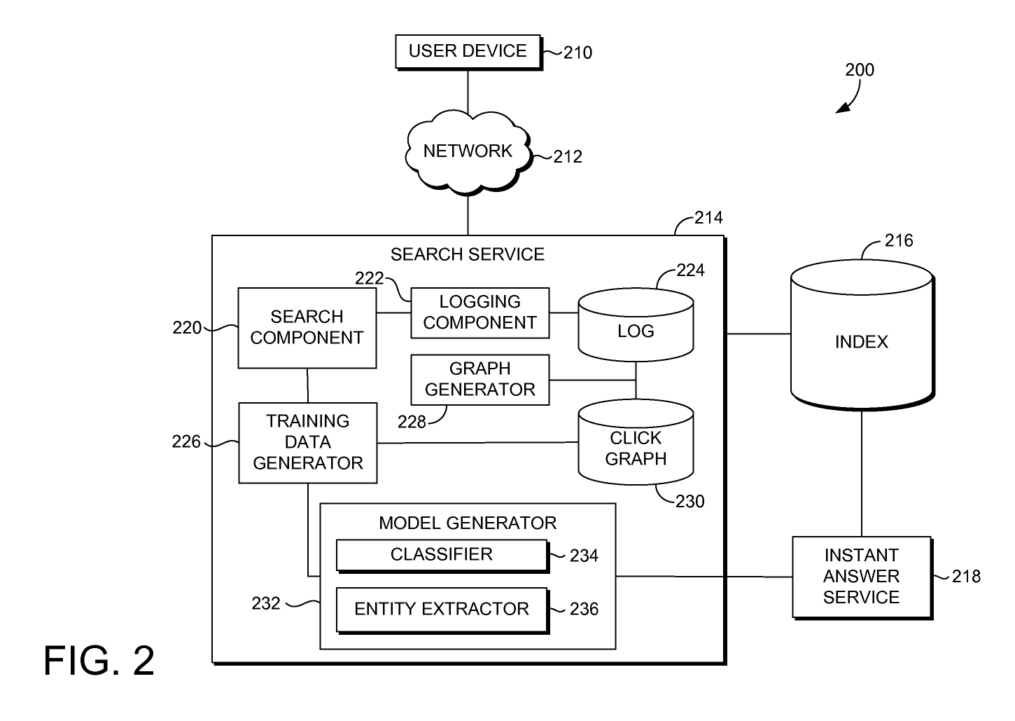

Turning now to FIG. 2, a block diagram of an exemplary network environment 200 suitable for use in implementing embodiments of the inventions is shown. Network environment 200 includes user device 210, network 212, search service 214, index 216, and instant answer service 218. User device 210 communicates with search service 214 and instant answer service 218 through network 212, which may include any number of networks such as, for example, a local area network (LAN), a wide area network (WAN), the Internet, a cellular network, a peer-to-peer (P2P) network, a mobile network, or a combination of networks. The exemplary network environment 200 shown in FIG. 2 is an example of one suitable network environment 200 and is not intended to suggest any limitation as to the scope of use or functionality of embodiments of the inventions disclosed throughout this document. Neither should the exemplary network environment 200 be interpreted as having any dependency or requirement related to any single component or combination of components illustrated therein.

User device 210 can be any kind of computing device capable of allowing a user to submit a search query to search service 214 and to receive, in response to the search query, a search results page from search service 214. For example, in an embodiment, user device 210 can be a computing device such as computing device 100, as described above with reference to FIG. 1. In embodiments, user device 210 can be a personal computer (PC), a laptop computer, a workstation, a mobile computing device, a PDA, a cell phone, or the like.

Search service 214, as well as any or all of the other components 216, 218 illustrated in FIG. 2 may be implemented as server systems, program modules, virtual machines, components of a server or servers, networks, and the like. In one embodiment, for example, each of the components 214, 216, and 218 is implemented as a separate server. In another embodiment, all of the components 214, 216, and 218 are implemented on a single server or a bank of servers.

In an embodiment, user device 210 is separate and distinct from search service 214 and/or the other components illustrated in FIG. 2. In another embodiment, user device 210 is integrated with one or more of components 214, 216, and 218. For clarity of explanation, we shall describe embodiments in which each of user device 210, and components 214, 216, and 218 are separate while understanding that this may not be the case in various configurations contemplated within the present invention.

As shown in FIG. 2, user device 210 communicates with search service 214. Search service 214 receives search queries, i.e., search requests, submitted by a user via user device 210. Search queries received from a user can include search queries that were manually or verbally inputted by the user, queries that were suggested to the user and selected by the user, and any other search queries received by the search service 214 that were somehow approved by the user. Search service 214 may be, or include, for example, a search engine, a crawler, or the like, and can interact with index 216 to perform searches. Search service 214, in some embodiments, is configured to perform a search using a query submitted through user device 210.

In various embodiments, search service 214 can provide a user interface for facilitating a search experience for a user communicating with user device 210. In an embodiment, search service 214 monitors searching activity, and can produce one or more records or logs representing search activity, previous queries submitted, search results obtained, and the like. These services can be leveraged to improve the searching experience in many different ways. As is further illustrated in FIG. 2, search service 214 communicates with instant answer service 218. Instant answer service 218 can be, in embodiments, any type of vertical-search service including, but not limited to, services that provide instant answers in response to queries.

As shown in FIG. 2, search service 214 includes search component 220, logging component 222, click log 224, training data generator 226, graph generator 228, click graph 230, and model generator 232. The exemplary search service 214 shown in FIG. 2 is an example of one configuration and is not intended to suggest any limitation as to the scope of use or functionality of embodiments of the inventions disclosed throughout this document. Neither should the exemplary search service 214 be interpreted as having any dependency or requirement related to any single component or combination of components illustrated therein.

Search component 220 is configured to receive a submitted query and to use the query to perform a search. In an embodiment, upon discovering query results that satisfy the submitted query, search component 220 returns the query results to user device 210 by way of a graphical interface maintained by search service 214. Query results can include content of any kind such as, for example, a list of documents, files, or other instances of content that satisfy the submitted query. In another embodiment, query results include the actual content that satisfies the submitted query. In still further embodiments, query results include links to content, suggestions for future queries, and the like. In an embodiment, search component 220 communicates a message to user device 210 if the submitted query does not yield any results. The message informs user device 210 that the submitted query did not yield any results.

In an embodiment, upon identifying search results that satisfy the search query, search component 220 returns a set of search results to user device 210 by way of a graphical interface such as a search results page. A set of search results includes representations of content or content sites (e.g., web-pages, databases, or the like that contain content) that are deemed to be relevant to the user-defined search query. Search results can be presented, for example, as content links, snippets, thumbnails, summaries, instant answers, and the like. Content links refer to selectable representations of content or content sites that correspond to an address for the associated content. For example, a content link can be a selectable representation corresponding to a uniform resource locator (URL), IP address, or other type of address. That way, selection of a content link can result in redirection of the user's browser to the corresponding address, whereby the user can access the associated content. One commonly used example of a content link is a hyperlink.

Logging component 222 captures click data generated during a user's interaction with search service 214. In embodiments, logging component 222 stores the captured click data in log 224. Log 224 can be, or include, a storage module (e.g., a database, index, table, or other storage), a history manager, and the like. Log 224 maintains click data associated with user search behavior. As used herein, “click data” refers to information that reflects the activity of a user with respect to the search service 214, and can include data captured from search queries issued by users, search results provided to the user in response to search queries, indications that a user selected (e.g., “clicked”) a search result or other content link, URLs associated with content links, dwell time (indicating the amount of time a user spends at a particular content site prior to returning to the search engine or viewing a search results page), and any other type of activity that can be monitored and recorded by tracking a user's inputs.

Training data generator 226 automatically generates positive training data for training a classifier 234 and/or an entity extractor 236. Using training data generator, URL patterns and entities are identified. Training data generator 226 identifies each node of a click-graph 230, which is generated from click log 224 by graph generator 228, that corresponds to a URL matching the pattern and/or including the entities. Queries associated with each of the matching nodes are added to a set of potential training data. Training data can be selected from the potential training data and used to train classifier 234 and/or entity extractor 236.

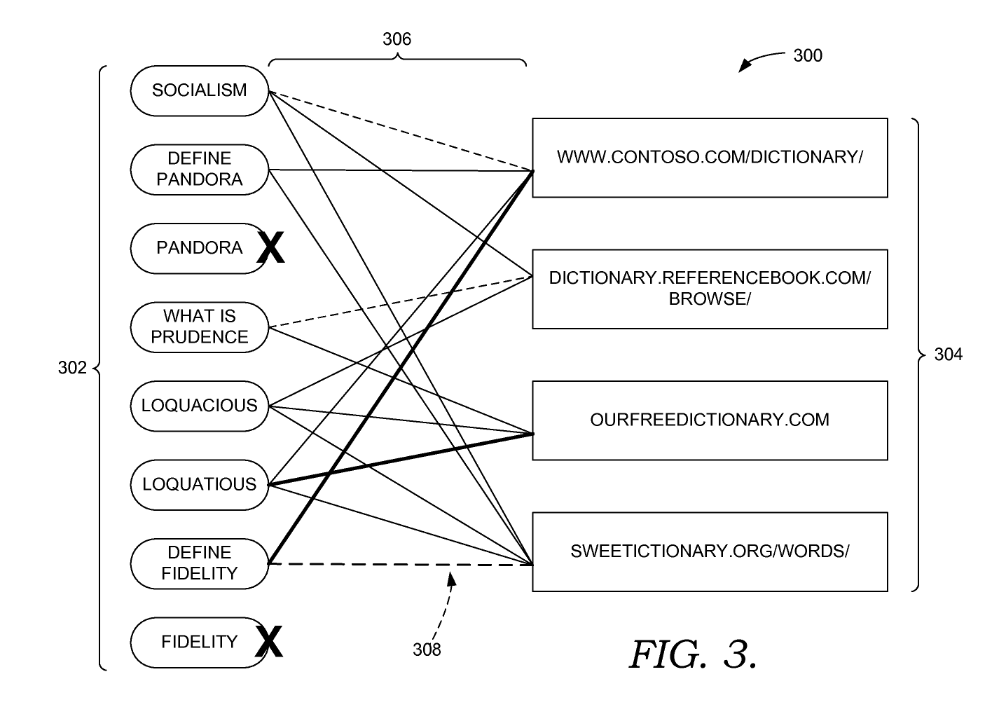

Turning briefly to FIG. 3, an example of a click graph 300 is depicted. The click graph 300 of FIG. 3 is representative of just a portion of a click-graph associated with URLs that all correspond to a common query-intent domain. The exemplary click-graph 300 shown in FIG. 3 is an example of one suitable data structure and is not intended to suggest any limitation as to the scope of use or functionality of embodiments of the inventions disclosed throughout this document. Neither should the exemplary click-graph 300 be interpreted as having any dependency or requirement related to any single component or combination of components illustrated therein.

As illustrated in FIG. 3, exemplary click-graph 300 has a number of query nodes 302 on the left and a number of URL nodes 304 on the right. Labeling of nodes 302 and 304 is not depicted in FIG. 3 because labeling nodes is not necessarily germane to the present discussion. Links (or edges) 306 connect certain pairs of query nodes 302 and URL nodes 304. Note that not all of the query nodes 302 or URL nodes 304 are linked. For example, the query node 302 corresponding to the search phrase “what is prudence” is linked to just the URL nodes “dictionary.referencebook.com/browse/” and “ourfreedictionary.com,” and to no other URL nodes in the click graph 300. What this means is that, in response to the search results to the search query containing the search phrase “what is prudence,” the user made a selection in the search results to navigate to the URLs “dictionary.referencebook.com/browse/” and “ourfreedictionary.com/,” and did not make selections to navigate to the other URLs depicted in FIG. 3 (or alternatively, the other URLs did not appear as search results in response to the query containing search phrase “what is prudence”).

Similarly, the query node 302 corresponding to the search term “fidelity” is not connected to any of the URL nodes 304 depicted in FIG. 3, for example, because the dominant intent associated with the query corresponding to query node 302 is a website associated with the well-known company named Fidelity. As used herein, “dominant intent” refers to a probable query intent that has a higher probability of corresponding to the user's actual intent than any other probable query intent associated with the particular query. Furthermore, in embodiments, each of the links 306 in FIG. 3 is associated with an edge weight 308 (referred to herein, interchangeably, as “weight” and conceptually represented in FIG. 3 by the various line styles depicted), which, in one example, can be a count (or some other value based on the count) of clicks made between the particular pair of a query node and a URL node. In other embodiments, other definitions of weight can be used, as well, such as a count of clicks made by a particular user, and the like.

Using techniques according to some embodiments, a relatively large portion (or even all) of the queries in the click graph 300 can be examined to identify potential training data. In the example of FIG. 3, the click graph 300 is a bipartite graph that contains a first set of nodes to represent queries and a second set of nodes to represent URLs, with edges (links) connecting correlated query nodes and URL nodes. In other embodiments, other types of data structures can be used for correlating queries with URLs based on click data, as well. Additionally, the click graph 300 shows URL nodes that represent corresponding individual URLs. Note that in an alternative embodiment, instead of each URL node representing an individual URL, a node 304 can represent a cluster of URLs that have been clustered together based on some similarity metric.

One way of constructing a click graph is to simply form a relatively large click graph based on collected click data. In some scenarios, particularly using known methods, this may be inefficient. Thus, to better utilize known methods, a more efficient manner of constructing a click graph is often employed and includes, building a compact click graph and then iteratively expanding the click graph until the click graph reaches a target size. However, embodiments of the invention allow for larger click-graphs to be used, eliminating the need for generating compact click graphs. For example, in an embodiment, a click graph for use with aspects of the invention can be generated using all of the click data available to it. In some cases, a search service can build click logs that contain a record of each query and corresponding clicks made by each user for many months at a time.

Returning to FIG. 2, as indicated above, training data generator 226 automatically generates training data by walking the click graph and identifying patterns that match selected or identified seed patterns. According to various embodiments, training data generator 226 accepts domains (or sub-domains) from the user as input. Such domains can be, for example, of the form “contoso.go.com” or “contosa.com/football/”. Training data generator 226 identifies matching nodes in the click graph by looking at every URL node in the click graph and selecting those nodes whose URL matches (at least in part) at least one of the domain inputs.

For each matching URL node, training data generator 226 can add to a potential result set each query that is connected to that node in the click graph, along with the edge weight of the query, which is found by examining the number of clicks produced for this URL when the query was issued. In some embodiments, it may be the case that the same query is added for two different URL nodes—in this case, for example, training data generator 226 can add their weights. Training data generator 226 then chooses as training queries those queries from the potential result set where the relative weight (e.g., accumulated weight divided by the total number of impressions for the query) is above a threshold (for example 0.1). Thus, for a threshold of 0.1, the query “chris brown” may have resulted in 25 clicks to the chosen sports URL nodes, but if the total number of times “chris brown” was issued to the search service 214 was greater than 250, it would not be used as automated training data.

Training data generator 226 provides the selected training data to model generator 232. Model generator 232 can be any type of program, module, API, or code that facilitates the generation of models such as, for example, classifier 234 and entity extractor 236. In embodiments, model generator 232 can generate models 234 and 236 and train models 234 and 236 using the training data generated by training data generator 226. In some embodiments, users can interact with model generator 232 to provide input to the model-generation process.

According to various embodiments of the invention, classifier 234 is a binary query-intent classifier for determining a domain associated with a user query. In other embodiments, classifier can be any type of classifier useful for categorizing incoming user search queries. Classifier 234 can take any number and type of data as inputs for classifying incoming queries. In embodiments, classifier 234 can be utilized to classify a query as belonging to one particular domain or not. In other embodiments, classifier 234 can be utilized to identify a domain to which the query corresponds. According to various embodiments of the invention, classifier 234 can be used for any number of reasons and can be implemented in according to any number of configurations in accordance with embodiments of the invention.

In embodiments, entity extractor 236 extracts entities from queries and facilitates segmenting queries into parts. Entities can include letters, characters, words, phrases, and the like. In embodiments, an entity is something that can be compared to another entity. That is, for example, an entity may be a product, a service, a person, a place, an activity, or the like. According to various embodiments of the invention, entity extractor 236 can identify (e.g., “extract”) entities, patterns of entities, relationships between entities, contextual information about entities, and the like. In embodiments, entity extractor 236 extracts a number of different combinations of entities and entity patterns from a given query.

As used herein, “entity pattern” refers to any arrangement of at least one entity. In embodiments an entity pattern can include a single entity, two entities, or more than two entities. In an embodiment, an entity pattern includes a representation of an association or relationship between two or more entities. For example, an entity pattern can reflect the position of the entities in the original search query. In embodiments, an entity pattern can refer to a type of data that is present in seed URLs. For example, suppose a set of selected seed URLs have various entities associated with music such as, for example, artist names, song titles, and album names. The set of these three types of entities could be referred to as an entity pattern and, accordingly, any URL having an entity of one of these three types could be identified as a matching URL.

Using some embodiments of the invention, the amount of training data that is available for training a query-intent classifier can be expanded in an automated fashion, for more effective training of a query-intent classifier and/or an entity extractor, and to improve the performance of such classifiers and extractors. In some cases, with the large amounts of training data that can be obtained in accordance with some embodiments, query-intent classifiers or entity extractors that use just query words or phrases as features can be relatively accurate and can, for example, enhance an instant answer service's ability to dynamically respond to users with relevant content.

Once the query-intent classifier has been trained, the query-intent classifier is output for use in classifying queries. For example, the query-intent classifier can be used in connection with a search engine. The query-intent classifier is able to classify a query received at the search engine as being positive or negative with respect to a query intent. If positive, then the search engine can invoke a vertical search service. On the other hand, if the query-intent classifier categorizes a received query as being negative for a query intent, then the search engine can perform a general purpose search.

Additionally, by implementing embodiments of the invention, click graphs can be generated and used that represent all of this click data. Because, in embodiments of the invention, there is no need for manually labeling any queries or applying a complex labeling algorithm to the click-graph, but rather a process of selecting URLs having matching subdomains, large sets of training data can be generated at a minimal cost to the search service.

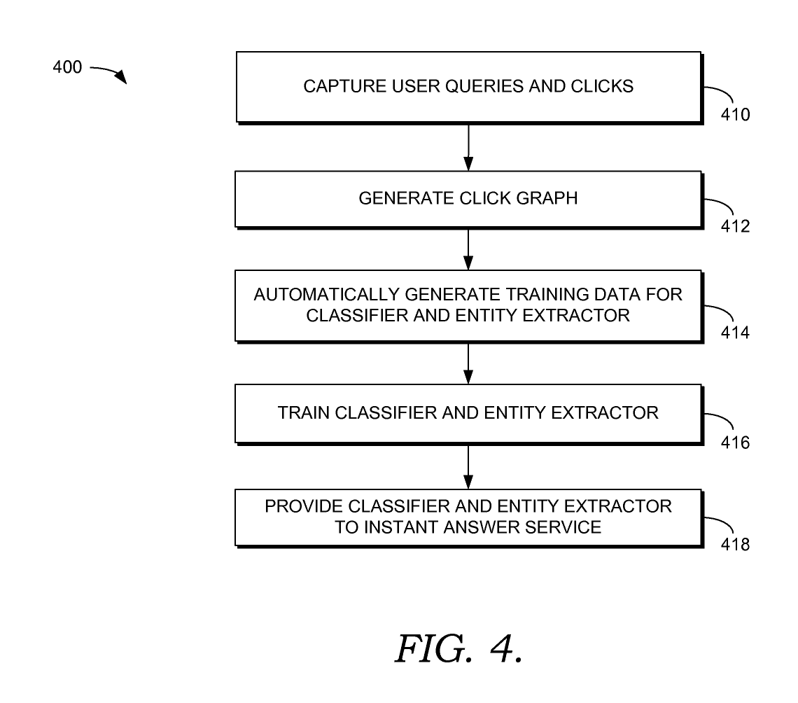

To recapitulate, the disclosure above has described systems, machines, media, methods, techniques, processes and options for automatically generating positive training data for use in training classifiers and/or entity extractors. Turning to FIG. 4, a flow diagram is illustrated that shows an exemplary method 500 of enhancing an instant-answer service by utilizing aspects of the training-data generation concepts described herein. A first illustrative step, step 410, includes capturing user queries and corresponding clicks. In embodiments, a search service can capture any number of different types of click data generated during a user's interaction with the search service. According to embodiments of the invention, queries submitted by users are captured, as are URLs corresponding to search results that the users selected (e.g., “clicked”). In embodiments, the click data can be stored in a click log.

As illustrated at step 412, a click graph is generated using the captured click data. As explained above, a click graph generally includes a first set of nodes to represent queries and a second set of nodes to represent URLs, with edges (links) connecting correlated query nodes and URL nodes. According to embodiments of the invention, the generated click graph can be of any size, including very large. For example, in an embodiment, the click graph can include click data associated with every interaction of every user for some period of time such as, for example, a week, a month, a year, and the like.

At step 414, embodiments of the illustrative method 400 include automatically generating training data for a classifier or an entity extractor. In embodiments, training data can be generated by identifying URL nodes having URLs that match specified URL patterns and selecting corresponding queries for training data. At step 416, the training data is used to train the classifier and/or extractor and, as shown at a final illustrative step, step 418, the search service provides the classifier and/or the entity extractor to an instant answer service for facilitating triggering instant answer services and identifying relevant instant answer content.

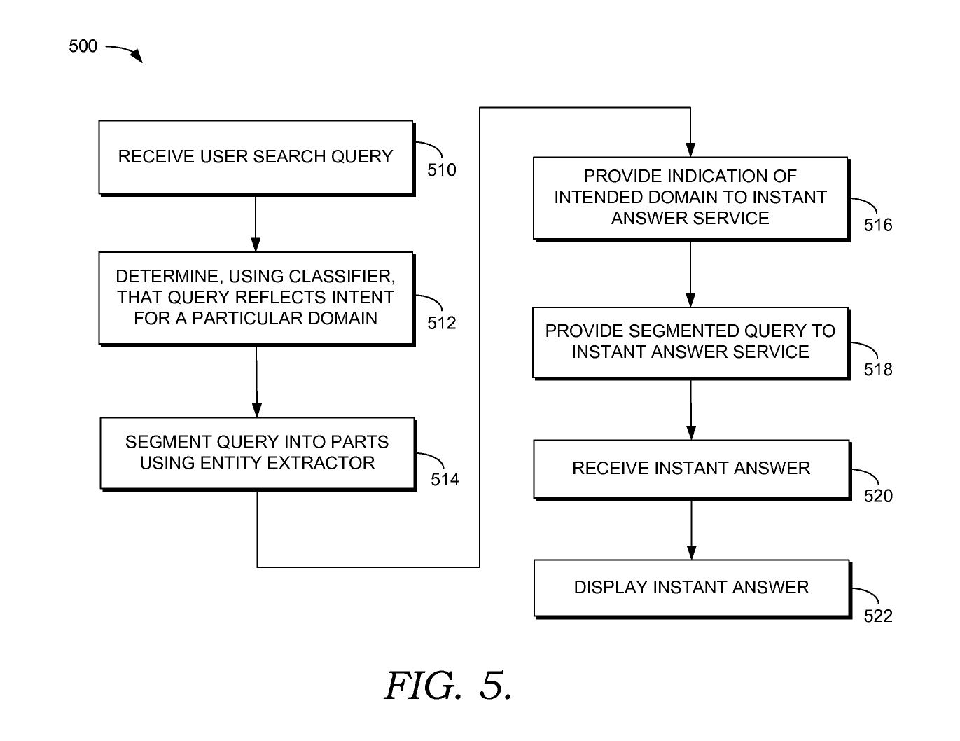

Turning to FIG. 5, a flow chart depicts an illustrative method 500 of utilizing a classifier and an entity extractor to trigger instant answer services. As shown at an illustrative first step, step 510, a search service receives a user search query. At step 512, the classifier is used to determine whether the query reflects user intent for a particular domain. That is, the classifier is used to determine whether the user's search is directed to a particular categorization of information such as, for example, movies, music, images, jobs, or the like.

As shown at step 514, a query that is identified as reflecting an intent for a particular domain is segmented, using an entity extractor, into a set of parts. In embodiments, the parts into which the query is segmented are based on characteristics of the intended domain. As is further illustrated in FIG. 5, the search service provides, at step 516, an indication of the intended domain and, at step 518, the segmented query to an instant answer service. At step 520, the search service receives an instant answer (e.g., content, a link, etc.) from the instant answer service and, in a final illustrative step 522, displays the instant answer to the user.

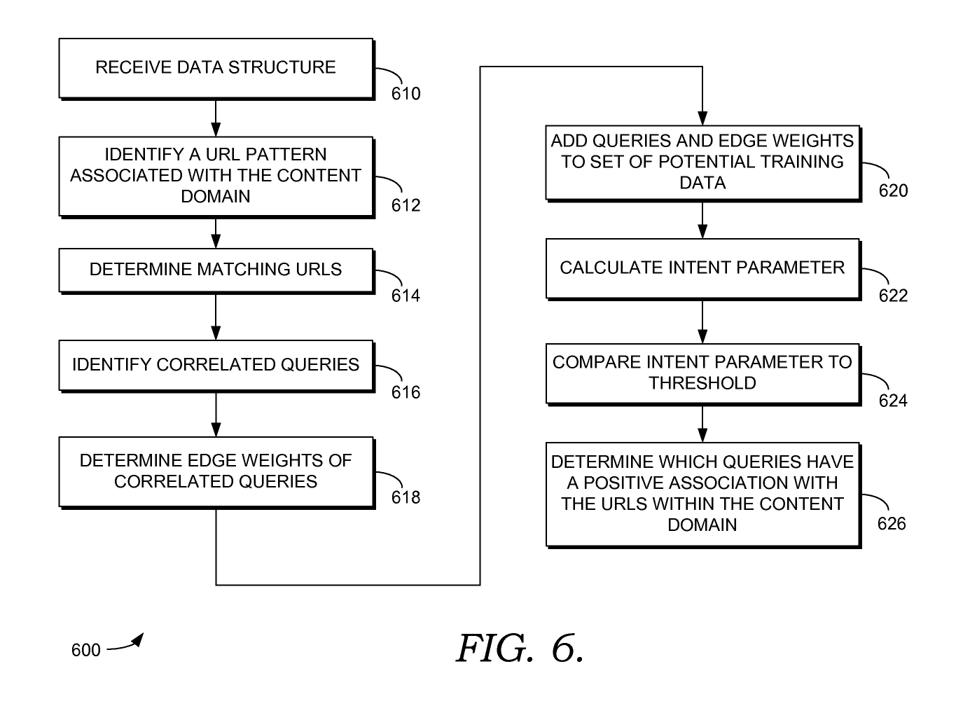

Turning now to FIG. 6, another flow diagram depicts an illustrative method 600 for identifying positive associations between queries and uniform resource locators (URLs) in click data with respect to a content domain. In embodiments, the illustrative method 600 includes, as shown at step 610, receiving a data structure. In embodiments, the data structure includes click data and is arranged in such a way as to correlate queries to URLs identified by the queries. According to some embodiments, the data structure is a click graph having a first set of nodes to represent queries and a second set of nodes to represent URLs, with edges connecting correlated query nodes and URL nodes.

At step 612, a URL pattern associated with the content domain is identified. In embodiments, the URL pattern can be identified by examining a set of seed URLs selected from the data structure. In other embodiments, the URL pattern can be specified based on the searching user, requirements of an instant answer service, or the like. In an embodiment, a number of URL patterns can be identified, as well. It should be apparent that URL pattern includes a URL domain. In embodiments, a URL pattern also includes at least one subdomain, which could be the domain itself. In embodiments, a URL pattern can be an entity pattern, as described herein, particularly with reference to FIGS. 2 and 3.

As illustrated at step 614, matching URLs are identified. In embodiments, matching URLs are URLs in the data structure that, at least partially, match the URL pattern. That is, in embodiments, at least a portion of a matching URL matches the identified URL pattern. In some embodiments of the invention, a number of URL patterns are identified and a matching URL is a URL that, at least partially, matches any one or more of the identified URL patterns. In further embodiments, any number of other criteria can be used to determine matching URLs. For instance, in an embodiment useful, for example, for training classifiers, the URL includes a URL subdomain that matches a URL subdomain of the URL pattern. In other embodiments, a matching URL can include an entity pattern that matches an entity pattern associated with the seed URLs.

With continued reference to FIG. 6, at step 616, each query correlated to each matching URL is identified and, at step 618, each edge weight of each of the correlated queries is identified and/or determined. In an embodiment, determining an edge weight associated with a query is performed by calculating a function that is based on a number of clicks associated with the first URL when the first URL was provided in response to the first query. At step 620, as illustrated in FIG. 6, the identified queries and their corresponding weights are added to a set of potential training data.

At step 622, embodiments of the illustrative method 600 include calculating an intent parameter value for each query in the set of potential training queries, which is compared, at step 624, to a threshold. In embodiments, for example, calculating a value of an intent parameter includes calculating a relative weight of a query. A query's relative weight, according to embodiments of the invention, can include a ratio of a total accumulated weight of the query to a total number of impressions of the query. In some embodiments, additional queries correlated to the URL can be identified. In this case, for example, the edges corresponding to both correlations can be summed to generate a total accumulated weight of a query.

As illustrated at a final illustrative step, step 626, embodiments of the illustrative method 600 include determining which queries have positive associations with their correlated URLs with respect to the content domain. In embodiments, queries having such positive associations (referred to herein, interchangeably, as “positive queries” or “positive data”) can be labeled as such in the click graph or other data structure. In some embodiments, positive queries can be selected as training data for training classifiers, entity extractors, and the like. Determining positive data can include comparing an intent parameter to a threshold, applying probabilistic algorithms and other machine-learning functions to the query data, and the like.

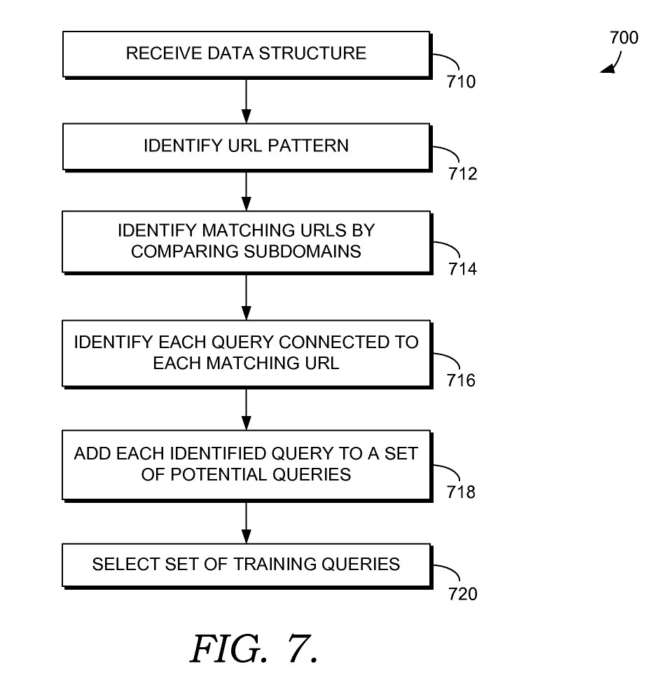

Turning now to FIG. 7, another flow diagram depicts an illustrative method 700 for generating positive classifier training data. According to embodiments of the invention, illustrative method 700 includes, at step 710, receiving a data structure correlating queries to URLs identified by the queries. For example, in an embodiment, the data structure is a click graph having a first set of nodes to represent queries and a second set of nodes to represent URLs, with edges connecting correlated query nodes and URL nodes.

At step 712, embodiments of the illustrative method 700 include identifying a URL pattern that includes a first URL domain and at least one URL subdomain. At step 714, matching URLs are identified by comparing subdomains of URLs in the data structure with the identified URL pattern. For example, in an embodiment, a matching URL in the data structure is one in which at least a portion of the matching URL matches at least a portion of the first URL domain. In an embodiment, the first URL domain includes a first URL subdomain and a matching URL includes a second URL subdomain that matches the first URL subdomain.

At step 716, each query connected to each matching URL is identified. As shown at step 718, each identified query is added to a set of potential training data and, as shown at a final illustrative step, step 718, a set of training queries is selected. In embodiments, for example, the selection of the set of training queries from the set of potential training queries is based on the edge weights of each query connected with the matching URLs.

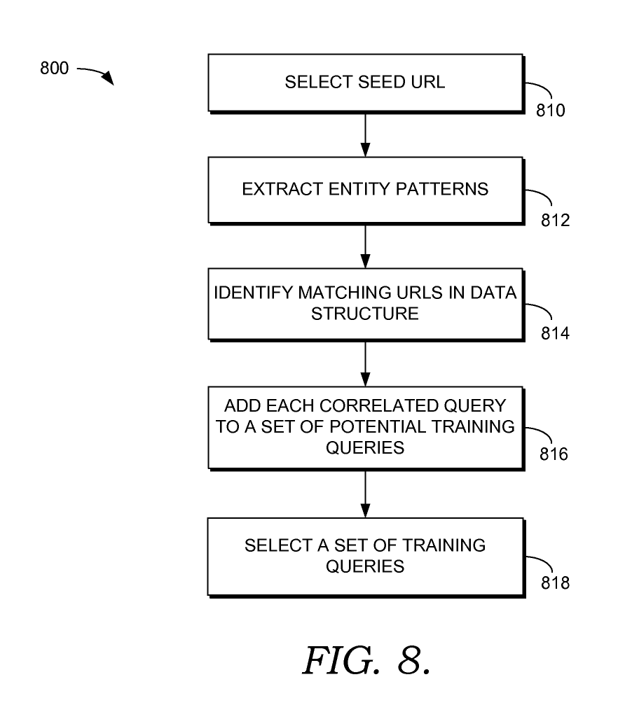

Turning now to FIG. 8, another flow diagram depicts an illustrative method 800 for generating entity-extractor training data from a data structure storing click data, wherein the data structure includes associations between captured search queries and uniform resource locators (URLs) corresponding to query results that were selected. At a first illustrative step, step 810, a seed URL is selected. In embodiments, a seed URL can be automatically selected, inputted by a user, designated by a network administrator, selected by an application, or any other suitable method of selecting a URL with which to begin a process. Additionally, in embodiments, a number of seed URLs can be selected such that patterns common to the URLs can be identified and used in the generation of training data.

At step 812, entity patterns are extracted. In embodiments, an entity pattern can consist of a single entity, while in other embodiments, an entity pattern can include a number of entities. Entities can have any number of arrangements and in some implementations, the arrangement of entities is relevant to identifying positive training data. In other embodiments, the training data generator might only be concerned with the entities themselves. In some embodiments, any number of entity patterns can be extracted. For example, in an embodiment, a first set of entity patterns might be selected from a first seed URL, and a second set of entity patterns can be selected from a second URL. In embodiments, entity patterns common to two or more URLs can be selected. It should be understood by those having knowledge of the art that any of the foregoing, combinations thereof, modifications thereof, and the like can be implemented in accordance with embodiments of the invention.

As illustrated at step 814, illustrative method 800 includes identifying matching URLs in the data structure. In some embodiments, identifying the matching URL in the data structure includes determining that the matching URL includes the entity patterns. In an embodiment, a matching URL can include all of the entity patterns and/or entities. In an embodiments, a matching URL includes at least a portion of an entity pattern, entity, or the like. Any number of other suitable criteria can be used for determining a matching URL such as thresholds associated with the number of entity patterns a URL includes, and the like.

At step 816, each correlated query and its weight is added to a set of potential training queries and at a final illustrative step, step 818, a set of training queries is selected from the set of potential training queries. As discussed above with reference to automatic generation of training data for classifiers, training queries for entity extractors such as the entity extractors described herein, can be selected by calculating an intent parameter for each query. Intent parameters can be, for example, based on edge weights of each query. Moreover, differences between extracted entity patterns and patterns in matching URLs could be analyzed and characterized numerically, or otherwise, for comparing to criteria, thresholds, and the like.

Various embodiments of the invention have been described to be illustrative rather than restrictive. Alternative embodiments will become apparent from time to time without departing from the scope of embodiments of the inventions. It will be understood that certain features and sub-combinations are of utility and may be employed without reference to other features and sub-combinations. This is contemplated by and is within the scope of the claims.

The invention claimed is:

1. One or more computer-readable media having embodied thereon computer-executable instructions that, when executed by a processor in a computing device associated with a search service, cause the computing device to perform a method of identifying positive associations between queries and uniform resource locators (URLs) in click data with respect to a content domain, the method comprising:
receiving a data structure correlating queries to URLs identified by the queries;
identifying a first URL pattern associated with the content domain;
determining that at least a portion of a first URL in the click graph matches the first URL pattern;
identifying a first query correlated to the first URL; and
determining that the first query and the first URL have a positive association with respect to the content domain.

2. The media of claim 1, wherein the search query includes a first entity and further wherein determining that the at least a portion of the first URL in the click graph matches the first URL pattern includes determining that the at least a portion of the first URL includes the first entity.

3. The media of claim 1, wherein the first URL pattern includes a first URL domain comprising a first URL subdomain.

4. The media of claim 3, wherein the at least a portion of the first URL includes a second URL subdomain and further wherein determining that the at least a portion of the first URL matches the first URL pattern includes determining that the second URL subdomain matches the first URL subdomain.

5. The media of claim 1, wherein determining that the first query and the first URL have a positive association with respect to the content domain includes:
calculating a value of an intent parameter, wherein the intent parameter is based on a weight associated with the first URL; and
determining that said value exceeds a specified threshold.

6. The media of claim 5, further comprising determining a first edge weight associated with said first query, wherein said first edge weight of said first query is based on a number of clicks associated with the first URL when the first URL was provided in response to the first query.

7. The media of claim 6, wherein calculating a value of an intent parameter includes calculating a relative weight of the first query, said relative weight comprising a ratio of a total accumulated weight of said first query to a total number of impressions of said first query.

8. The media of claim 7, further comprising:
determining that the first query is also correlated to a second URL in the click graph;
determining a second edge weight of said first query, wherein said second edge weight of said first query is based on a number of clicks associated with the second URL when the second URL was provided in response to the first query; and
calculating the total accumulated weight of said first query by summing the said first edge weight and said second edge weight.

9. The media of claim 1, wherein said data structure is a click graph having a first set of nodes to represent queries and a second set of nodes to represent URLs, with edges connecting correlated query nodes and URL nodes.

10. One or more computer-readable media having embodied thereon computer-executable instructions that, when executed by a processor in a computing device associated with a search service, cause the computing device to perform a method of generating positive classifier training data, the method comprising:
receiving a data structure correlating queries to URLs identified by the queries;
identifying a first URL pattern comprising a first URL domain;
identifying a matching URL in the data structure, wherein at least a portion of the matching URL matches at least a portion of the first URL domain;
adding each query connected with the matching URL to a set of potential training queries; and
selecting a set of training queries from the set of potential training queries.

11. The media of claim 10, wherein the first URL domain includes a first URL subdomain and wherein the matching URL includes a second URL subdomain.

12. The media of claim 11, wherein identifying a matching URL includes determining that the second subdomain matches the first subdomain.

13. The media of claim 10, wherein said data structure is a click graph having a first set of nodes to represent queries and a second set of nodes to represent URLs, with edges connecting correlated query nodes and URL nodes.

14. The media of claim 10, further comprising adding an edge weight of each query connected with the matching URL to the set of potential training queries.

15. The media of claim 14, wherein the selection of the set of training queries from the set of potential training queries is based on the edge weights of each query connected with the matching URL.

16. One or more computer-readable media having embodied thereon computer-executable instructions that, when executed by a processor in a computing device, cause the computing device to perform a method of generating entity-extractor training data from a data structure storing click data, wherein the data structure includes associations between captured search queries and uniform resource locators (URLs) corresponding to query results that were selected, the method comprising:
selecting a seed URL;
extracting a first entity from the seed URL;
identifying a matching URL in the data structure, the matching URL comprising the first entity;
adding each query connected with the matching URL to a set of potential training queries; and
selecting a set of training queries from the set of potential training queries.

17. The media of claim 16, further comprising extracting a first entity pattern from the seed URL, wherein the first entity pattern includes the first entity and a second entity according to a first arrangement.

18. The media of claim 17, wherein identifying the matching URL in the data structure includes determining that the matching URL includes the first entity pattern.

19. The media of claim 16, further comprising training an entity extractor using the set of training queries.

20. The media of claim 16, wherein said data structure is a click graph having a first set of nodes to represent queries and a second set of nodes to represent URLs, with edges connecting correlated query nodes and URL nodes.
